(19) United States
(12) Patent Application Publication
(10) Pub. No.: US 2025/0136463 A1
(43) Pub. Date: May 1, 2025

(54) METHODS AND SYSTEMS FOR ENHANCING CARBONATE-OXIDE THERMAL CYCLING EFFICIENCY FOR CO2 DIRECT AIR CAPTURE

(71) Applicant: Battelle Memorial Institute, Richland, WA (US)

(72) Inventors: Nabajit Lahiri, Pasco, WA (US); Quin R.S. Miller, Richland, WA (US); Herbert T. Schaef, West Richland, WA (US); Casie L. Davidson, Richland, WA (US)

(21) Appl. No.: 18/934,947

(22) Filed: Nov. 1, 2024

Related U.S. Application Data
(60) Provisional application No. 63/546,895, filed on Nov. 1, 2023.

(51) Int. Cl. C01F 11/18; B01D 53/14

(52) U.S. Cl. CPC C01F 11/18; B01D 53/1475; B01D 2252/10; B01D 2257/504; C01P 2002/52; C01P 2002/72; C01P 2002/88; C01P 2002/89

(57) ABSTRACT

A composition may include an engineered synthetic carbonate comprising a structure, morphology, or combination thereof differing relative to a reference carbonate, wherein. A composition may include a thermal decomposition threshold of the engineered synthetic carbonate is in a range of from about 5% to about 30% less than the reference carbonate.

### CROSS-REFERENCE TO RELATED APPLICATION

This application claims the benefit of priority to U.S. Provisional Patent Application Ser. No. 63/546,895 entitled “METHODS AND SYSTEMS FOR ENHANCING CARBONATE-OXIDE THERMAL CYCLING EFFICIENCY FOR CO₂ DIRECT AIR CAPTURE,” filed Nov. 1, 2023, the disclosure of which is incorporated herein in its entirety by reference.

### STATEMENT OF GOVERNMENT SUPPORT

This invention was made with Government support under Contract DE-AC0576RL01830 awarded by the U.S. Department of Energy. The Government has certain rights in the invention.

### BACKGROUND

Direct air capture technology is a form of carbon dioxide (CO₂) removal that takes CO₂ from ambient, or still, air. The separated CO₂ can then be permanently stored deep underground, or it can be converted into products.

### SUMMARY

In some aspects, the techniques described herein relate to a composition including: an engineered synthetic carbonate including a structure, morphology, or combination thereof differing relative to a reference carbonate, wherein a thermal decomposition threshold of the engineered synthetic carbonate is in a range of from about 5% to about 30% less than the reference carbonate.

In some aspects, the techniques described herein relate to a method of enhancing carbonate-oxide thermal cycling efficiency for CO2 direct air capture, the method including: modifying a structure and morphology of a carbonate mineral to lower its thermal decomposition threshold for generating an oxide.

In some aspects, the techniques described herein relate to a method for capturing carbon dioxide, the method including: contacting carbon dioxide with an engineered synthetic carbonate including a structure, morphology, or combination thereof differing relative to a reference carbonate; and exposing the contacted engineered synthetic carbonate to a temperature less than about 950° C. to thermally decompose the engineered synthetic carbonate.

### BRIEF DESCRIPTION OF THE FIGURES

FIG. 1A is a graph showing sample mass loss (mass %) using thermogravimetric analysis.

FIG. 1B is a graph showing mass-spectrometry ion current curves.

FIG. 2 shows x-ray diffractograms showing the post-hydration products.

FIG. 3A is a graph showing Thermogravimetric Analysis-Mass Spectrometry of evolved water (m/z=18).

FIG. 3B is a graph showing Thermogravimetric Analysis-Mass Spectrometry of CO₂ (m/z=44, b).

FIG. 3C shows mass-normalized ion current curves and sample mass loss for 24 hours and 48 hours carbonation runs.

FIG. 4 a graph showing Thermogravimetric Analysis-Mass Spectrometry of evolved CO₂ (m/z=44) mass-normalized ion current curves for the fully carbonated Mg-doped samples and a commercial grade calcite sample.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

According to various aspects of the disclosure an engineered synthetic carbonate sorbent and method of direct air capture using the engineered synthetic carbonate material is described. Generally, direct air capture of carbon dioxide using a carbonate sorbent is a process designed to remove CO₂ directly from the atmosphere. This process begins by drawing air to the sorbent. As an example, air can be drawn in with large fans. The air, containing atmospheric concentrations of CO₂, is then directed through a contactor structure housing the carbonate sorbent.

In some examples, the ambient air can be supplemented with water (liquid or vapor). Supplementing ambient air with water in direct air capture processes can significantly enhance the efficiency and effectiveness of CO₂ removal. Water plays a role in the chemical reactions involved in carbonate-based direct air capture systems. When ambient air is passed through the contactor containing the carbonate sorbent, the presence of water facilitates the formation of bicarbonate, which is the key step in capturing CO₂. The reaction between CO₂ and the carbonate requires water to form bicarbonate. By ensuring an adequate supply of water, the reaction kinetics can be optimized, potentially increasing the rate and capacity of CO₂ absorption. Additionally, maintaining proper humidity levels in the air stream can prevent the drying out of the sorbent solution, which could otherwise reduce its effectiveness. Water also plays a role in the regeneration process, where heat is applied to release the captured CO₂ and regenerate the carbonate sorbent. Adding water also allows for the direct air capture system to be used in arid environments where the ambient air lacks humidity.

As the air flows through the contactor, a chemical reaction occurs between the CO₂ and the carbonate solution. This reaction transforms the carbonate into bicarbonate, effectively capturing the CO₂ from the air. The process can be represented by the chemical equation: CO₂+H₂O+CT₂CO₃→2CTHCO₃. As used herein “CT” refers to the cation of the carbonate. Once the sorbent becomes saturated with CO₂, it undergoes a regeneration process. This typically involves heating the solution, which reverses the absorption reaction and releases concentrated CO₂. The regeneration reaction can be expressed as: 2CTHCO₃→CT₂CO₃+H₂O+CO₂.

Following regeneration, the released CO₂ can be captured, purified, and compressed for storage or utilization. Meanwhile, the carbonate solution is cooled and recycled back to the contactor for reuse in capturing more CO₂. This process can operate continuously, with air constantly being drawn in and CO₂ being captured and released.

However, current direct air capture approaches require a significant amount of energy for heating CO₂-sorbed materials for regeneration, and in compressing the CO₂ for transportation purpose. For example, the regeneration step is often highly energy intensive, requiring temperatures as high as 1200° C. to achieve the thermal decomposition temperature of the carbonate solution. These high temperatures can render the entire process uneconomical (particularly at industrial scale) owing to the energy required to achieve these temperatures.

The instant disclosure provides an engineered synthetic carbonate material that is capable of sorbing CO₂, but has a much lower thermal decomposition temperature than conventional carbonate materials used in direct air capture methods. The carbonate materials that can be used include calcium carbonate and magnesium carbonate as well as sodium carbonate, potassium carbonate, lithium carbonate, ammonium carbonate, and various transition metal carbonates. The engineered synthetic carbonate material is modified in that the crystal structure differs from that of the respective carbonate. The engineered synthetic carbonate is contrasted herein to a reference carbonate. The reference carbonate means a carbonate that is does not have its crystal structure modified in a manner corresponding to that of the engineered synthetic carbonate.

Calcium carbonate primarily exists in two polymorphic forms: calcite and aragonite. Calcite, the more stable form at standard temperature and pressure, crystallizes in the trigonal-rhombohedral crystal system. Its structure consists of alternating layers of calcium ions and carbonate groups. Each calcium ion is coordinated with six oxygen atoms from different carbonate groups, forming a distorted octahedral arrangement. The carbonate groups are planar and oriented perpendicular to the c-axis of the crystal. This structure gives calcite its characteristic rhombohedral cleavage and optical properties.

Aragonite, the metastable polymorph of calcium carbonate, crystallizes in the orthorhombic system. In this structure, the calcium ions are coordinated with nine oxygen atoms from six different carbonate groups, resulting in a more densely packed arrangement compared to calcite. The carbonate groups in aragonite are slightly distorted from their planar configuration, contributing to the crystal's unique properties.

Magnesium carbonate, also known as magnesite, typically crystallizes in the trigonal-rhombohedral system, similar to calcite. However, the smaller size of the magnesium ion compared to calcium results in some structural differences. In magnesite, each magnesium ion is coordinated with six oxygen atoms from six different carbonate groups, forming a more regular octahedral arrangement than in calcite. The carbonate groups maintain their planar configuration and are oriented perpendicular to the c-axis of the crystal.

Both calcium and magnesium carbonates can form hydrated structures. For example, calcium carbonate can form ikaite (CaCO₃·6H₂O) under specific conditions, while magnesium carbonate can form various hydrates such as nesquehonite (MgCO₃·3H₂O) and lansfordite (MgCO₃·5H₂O). These hydrated forms have more complex crystal structures due to the incorporation of water molecules into the crystal lattice.

The aforementioned crystal structures can be modified (e.g., form a destabilized crystal structure) through inducing a defect in the structure, amorphization, including a dopant in the structure, or a combination thereof.

For calcium carbonate, defects can be introduced by incorporating foreign ions into the crystal structure. For example, introducing magnesium ions (Mg²⁺) into calcite can create point defects, as the smaller Mg²⁺ ions replace some of the larger Ca²⁺ ions. This substitution causes local distortions in the crystal lattice, affecting its properties. Another method is to induce dislocations through mechanical stress, such as grinding or applying pressure. These dislocations are linear defects that can significantly alter the crystal's mechanical and chemical properties.

In the case of magnesium carbonate, similar techniques can be applied. Introducing larger ions, like calcium, into the magnesite structure can create point defects. Additionally, rapid precipitation of magnesium carbonate can lead to the formation of various defects, including vacancies and interstitials, as the crystal growth occurs too quickly for perfect ordering.

Amorphization, the process of converting a crystalline material into an amorphous state, can be induced in both calcium and magnesium carbonates through several methods. One common approach is mechanical milling, where prolonged grinding breaks down the long-range order of the crystal structure. High-energy ball milling, for instance, can gradually transform crystalline carbonates into an amorphous state.

Another method to induce amorphization is through rapid quenching from a molten state. By melting the carbonate and then cooling it extremely quickly, the atoms do not have sufficient time to arrange themselves into an ordered crystal structure, resulting in an amorphous solid. However, this method is challenging for carbonates due to their thermal decomposition at high temperatures.

Irradiation techniques, such as ion bombardment, can also be used to induce amorphization in these carbonates. High-energy particles disrupt the crystal structure, creating a cascade of defects that can ultimately lead to complete loss of long-range order if the dose is sufficiently high.

Doping the crystal structures of calcium carbonate and magnesium carbonate can be accomplished with elements like magnesium, manganese, nickel, copper, or lithium. Doping involves introducing these foreign ions into the crystal lattice. This process can significantly alter the properties of the original crystals, including lowering its thermal decomposition temperature.

For calcium carbonate, doping with magnesium is particularly effective for lowering the thermal decomposition temperature. When magnesium ions (Mg²⁺) are incorporated into the calcite structure, they replace some of the calcium ions (Ca²⁺). Due to the smaller size of Mg²⁺ compared to Ca²⁺, this substitution creates local distortions in the crystal lattice. These distortions can affect various properties of the crystal.

Doping with manganese, nickel, or copper in calcium carbonate typically involves these transition metal ions substituting for calcium in the crystal structure. These substitutions can introduce new properties to the material.

In the case of magnesium carbonate, doping with larger ions like calcium or transition metals (manganese, nickel, copper) can create point defects in the crystal structure. These defects arise from the size mismatch between the dopant ions and the magnesium ions they replace.

Lithium doping in both calcium and magnesium carbonates is less common due to the significant size difference between Li⁺ and Ca²⁺ or Mg²⁺. However, when achieved, lithium doping can alter the properties of the material.

The dopant ranges from about 0.05 wt % to about 15 wt % of the engineered synthetic carbonate, about 2 wt % to about 7 wt % of the engineered synthetic carbonate, less than, equal to, or greater than about 0.05 wt %, 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, or about 17.5 wt % of the engineered synthetic carbonate. The dopant can be homogeneously distributed about the engineered synthetic carbonate. A homogeneous distribution of the dopant in the crystal structure refers to the substantially uniform and even dispersion of the dopant atoms or ions throughout the crystal lattice. In this scenario, the dopant atoms are randomly distributed across the crystal, maintaining a consistent concentration at any given point within the structure. In some examples, the dopant can be distributed heterogeneously or in a graded distribution. A heterogeneous or graded distribution of a dopant in a crystal structure refers to a non-uniform dispersion of the dopant atoms or ions throughout the host crystal lattice. In this scenario, the concentration of the dopant varies across different regions of the crystal, creating a gradient or localized areas of higher or lower dopant concentration.

In examples, where the dopant is homogenously distributed, the homogenous distribution can be achieved by mixing the carbonate and dopant through grinding, controlled co-precipitation during crystal growth, ion implantation with subsequent annealing, or solid-state diffusion at elevated temperatures.

In some examples, it is possible for the modification to be reversible. For example, the dopant may be expelled from the carbonate material, or the crystal structure can recover to its original state. In cases where the modification may be reversible, it may be desirable to limit the amount of contact time between the ambient air (and therefore CO₂) to a time ranging from about 2 hours to about 72 hours, about 10 hours to about 48 hours, less than, equal to, or greater than about 2 hours, 4, 6, 8, 10, 12, 14, 16, 18, 20, 22, 24, 26, 28, 30, 32, 34, 36, 38, 40, 42, 44, 46, 48, 50, 52, 54, 56, 58, 60, 62, 64, 66, 68, 70, or about 72 hours.

Modifying the carbonate lowers the thermal decomposition threshold of the carbonate is in a range of from about 5% to about 30% less than the reference carbonate, about 10% to about 25%, less than, equal to, or greater than about 5%, 6, 7, 8, 9, 10, 11, 12, 13, 14, 15, 16, 17, 18, 19, 20, 21, 22, 23, 24, 25, 26, 27, 28, 29, or about 30%. More specifically, the thermal decomposition temperature can be in a range of from about 600° C. to about 950° C., about 600° C. to about 800° C., about 700° C. to about 750° C., less than, equal to, or greater than about 600° C., 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940 or about 950° C.

Thus in operation, it takes less heat and therefore less energy to release CO₂ from the engineered synthetic carbonate material relative to a reference carbonate. This makes the overall direct air capture process more economically feasible and more desirable.

### Examples

Various aspects of the present disclosure can be better understood by reference to the following Examples which are offered by way of illustration. The present disclosure is not limited to the Examples given herein.

### Methods and Materials

### Materials

Eight solid metal salt candidates were selected as dopants: CuCl₂, MnCl₂, MgCl₂, NiCl₂, Na₃PO₄·12H₂O, Na₂CO₃, LiCl, and KCl. Pure lime (CaO) and Pure calcite (CaCO₃) were acquired from Sigma-Aldrich. Milli-Q water (Ω=18 mOhm) was used to prepare metal salt solutions for sparging on to CaO to prepare portlandite (Ca(OH)₂). All samples were grounded to fine powder using agate mortar and pestle before each step. The purpose was to break apart the mm-size loosely cemented chunks formed from the previous step.

### Sample Characterization

Thermal decomposition behavior of carbonates was analyzed using Thermogravimetric Analysis-Mass Spectrometry (TGA-MS). The measurement was conducted on a 2022 NETZSCH TG 209 F1 Libra thermo-microbalance coupled to a NETZSCH QMS 403 Aëolos Quadro mass spectrometer with a 300° C. heated capillary inlet system. The heating was purged under nitrogen gas with 20 mL/min flow rate. The heating started at room temperature (about 28° C.) and stopped when the temperature reaches 1,000° C. at a rate of 10° C./min. An empty 85 L corundum crucible was run dry on the TGA-MS system using the heating regimen described above to create a correction file for buoyancy factors associated with unique crucible weight. Each of the samples was then loaded into the crucible for analysis.

The mineralogic composition of the samples was determined via powder X-Ray Diffraction (XRD) analysis. Scans were conducted using a Bruker D8 Discover TXS-HE A25, equipped with a rotating Cu anode (Kα λ=1.5418 Å), 0.3×3 mm cassette tungsten filament, Atlas goniometer, and a UMC 1516 motorized xyzϕχz stage. The power settings of the generator were 45 kV and 120 mA for all measurements. Powder samples prepared with an agate mortar and pestle were mounted in a low-background silicon powder mounts or borosilicate capillaries and positioned using a laser-video alignment system. Thin-walled (0.01 mm) 0.8 mm internal diameter Charles Supper Company borosilicate glass capillary tubes were used for microdiffraction samples. Preliminary scans established the 20 range of interest and optimal instrument configuration. Bulk powder scans were collected with the XRD instrument in Bragg-Brentano geometry with the detector positioned at 425 mm from the sample. The X-ray beam passed through a Ni filter, 1.0 mm divergence slit, and 2.5° axial Soller. A panoramic 2.5 Soller attachment was placed on the Dectris EIGER2 R 500 K detector. Microdiffraction measurements of samples in capillaries was conducted with the detector at 206 mm from the sample in 2D mode. The X-ray were focused into a point using a Montel optic and 1 mm collimator. Scans were imported into Bruker EVA6.0 software for phase identification using the International Center for Diffraction Database powder diffraction file (PDF) 5+2024 database. Bruker AXS TOPAS 6 was used for quantitative Rietveld refinement of the sample using phases identified in EVA software.

### Results and Discussion

### Initial Dopant Screening and Down Selection

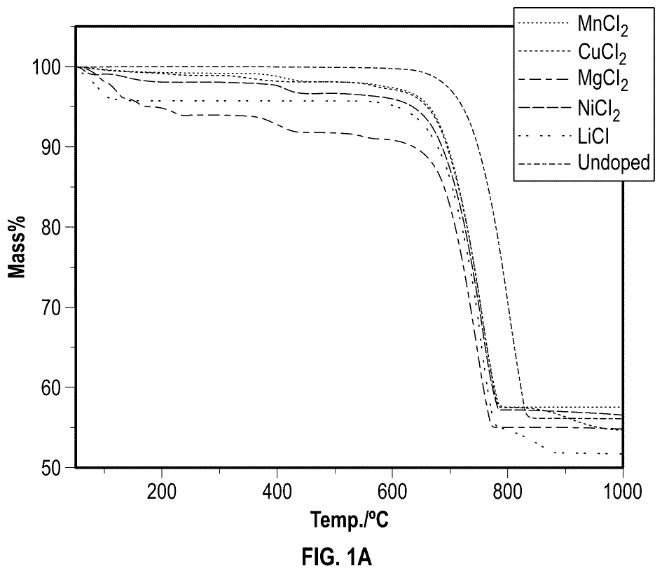

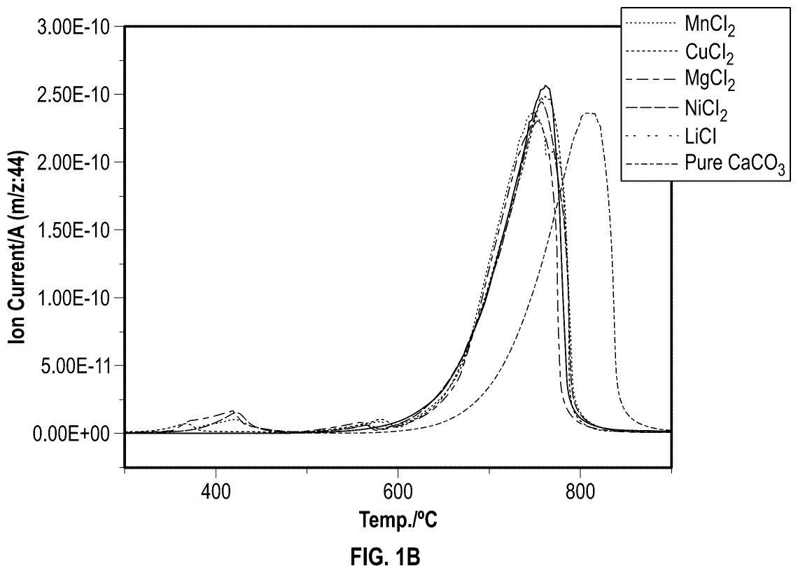

A preliminary dopant screening analysis was performed to enable down-selection of doping agents. Nine dopants were each well ground and homogenously mixed (5 wt %) with calcium carbonate. All chemicals used were acquired from Sigma-Aldrich. TGA-MS was utilized to heat the mixture at a rate of 10 C/min, while continuously analyzing the evolved gases (FIGS. 1A and 1B). As seen in Table 1 above, for pure CaCO₃, the temperature corresponding to maximum CO₂ evolution during decomposition was found to be 811° C. While all dopants used seemed to reduce this temperature threshold to some extent, the maximum reduction was

TABLE 1
Summary of TGA-MS analysis showing reduction in
decomposition temperature of CaCO₃ via doping.

| | Decomp. temp. of | | |
|---|---|---|---|
| Dopant | doped CaCO₃ (° C.)* | ΔT (° C.)^{#} | % Change^{#} |
| MnCl₂ | 749.6 | 61.4 | 7.6 |
| MgCl₂ | 751.6 | 59.4 | 7.3 |
| NiCl₂ | 759.3 | 51.7 | 6.4 |
| CuCl | 759.7 | 51.3 | 6.3 |
| LiCl | 762.8 | 48.2 | 5.9 |
| Na₂CO₃ | 783.7 | 27.3 | 3.4 |
| Na₃PO₄ | 789.6 | 21.4 | 2.6 |
| KCl | 793 | 18 | 2.2 |

*Decomposition temperature of undoped CaCO₃ was found to be

found to be for Mn²⁺ or Mg²⁺ doping. However, the use of Mn²⁺ as the dopant, however, resulted in the formation of calcium manganate, which is unusable in cyclic carbonate looping process. Therefore, the methodology primarily focused on the use of Mg²⁺ as the dopant.

### Carbon Capture Process Optimization

Each carbon capture cycle started with the hydration step, where calcium oxide (CaO) powder was fully hydrated to portlandite using deionized (DI) water (Eq.(1)). For the carbonation step, the hydrated sample was then placed in a relative humidity and temperature-controlled flow-through system to be exposed to breathing air (Eq.(2)). The final step was to calcine the fully carbonated samples to form the starting material, calcium oxide (Eq.(3)).

$$CaO + {H}_{2} O \to {Ca ( OH )}_{2} \qquad ( 1 )$$

$$Ca {( OH )}_{2} + {CO}_{2} \to {CaCO}_{3} + {H}_{2} O \qquad ( 2 )$$

$${CaCO}_{3} {\to }^{( 2 - 5 wt \% Dopant )} CaO + {CO}_{2} \qquad ( 3 )$$

Three cycles of hydration-carbonation-calcination experiments were conducted. The first set of cyclic experiments started with MgCl₂-doped calcium oxide, the second set of cyclic experiments was the same as the first set, except for the re-doping of MgCl₂ at the hydration step of each cycle. The third set of cyclic experiments started with calcium oxide without any dopant. The following sections provide more detail into the methodologies used in each step of the carbonation process and more information regarding the claims listed.

### Hydration and Doping

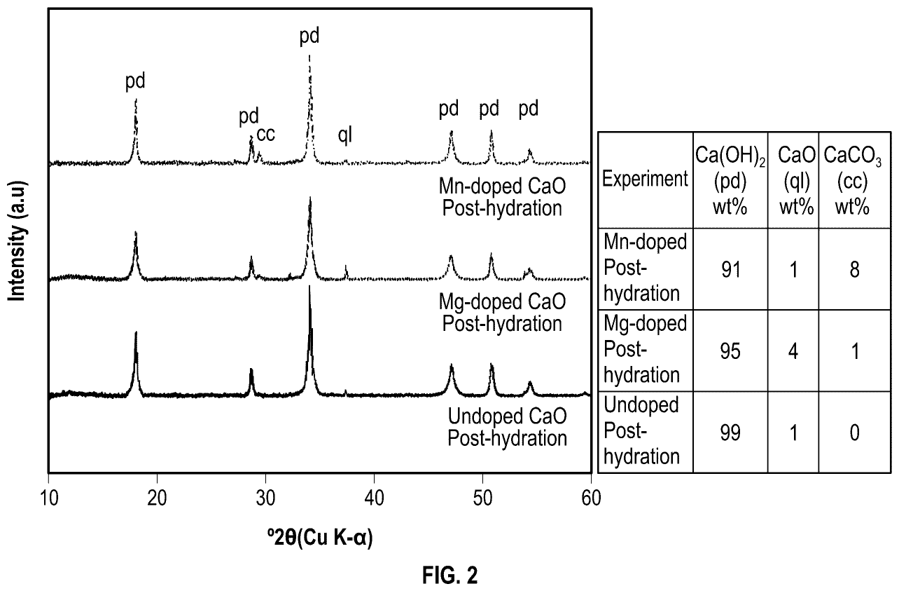

CaO was ground to a fine powder using agate mortar and pestle for each set of experiments. The weighted CaO samples were then placed in 20 mL glass vials with polyethylene screw caps. DI water was then added to the vials using pipette until the theoretical amount (1:1 molar ratio) was reached. The volume of DI water needed to fully hydrate the quicklime was calculated based on the mass of the quicklime using stoichiometry of Eq.(1). For the doped experiments, MgCl₂ (2-8 wt %) was first fully dissolved in DI water before adding to the quicklime. Doping CaO with three different amounts of MgCl2 (2 wt %, 5 wt %, and 8 wt %) did not result in a significant decomposition temperature variation. Because the hydration reaction is exothermic, the glass vials were quickly sealed by the screw caps and parafilm to prevent loss of water. The hydration reactions were allowed to sit for at least 2 hours before moving on to the carbonation step. XRD analysis of the product confirmed near complete conversion of CaO to Ca(OH)₂ (FIG. 2). Other hydration apparatus such as steam slacker, etc. can also be used for this step.

### Carbonation (Carbon Capture Step)

It was found that maintaining high relative humidity (RH) (>85%) is necessary to accelerate the carbonation process. At moderate relative humidity (˜40% RH to ˜75% RH), a dense protective layer can be formed around the reacting particles by carbonate minerals. However, at very high RH (>90%), the water film on the portlandite surface consists of a higher number of water monolayers, which allows the calcium carbonate to nucleate in the aqueous layer as well as at the crystal/solution interface. To maintain high relative humidity, an evaporating dish filled with a saturated solution of potassium sulfate (K₂SO₄) was placed in the lower level of the carbonation chamber which is separated from the upper level by a ventilated polyethylene plate. Additionally, the breathing air used for the carbonation process was bubbled through deionized water to humidify it. This experimental set up was able to maintain relative humidity values above 85% at all times in the carbonation chamber. After the hydrated samples were finely grounded, the samples were spread out to a thin layer (1-3 mm) on weigh boats and placed in the carbonation chamber.

### Optimization of Carbonation Time

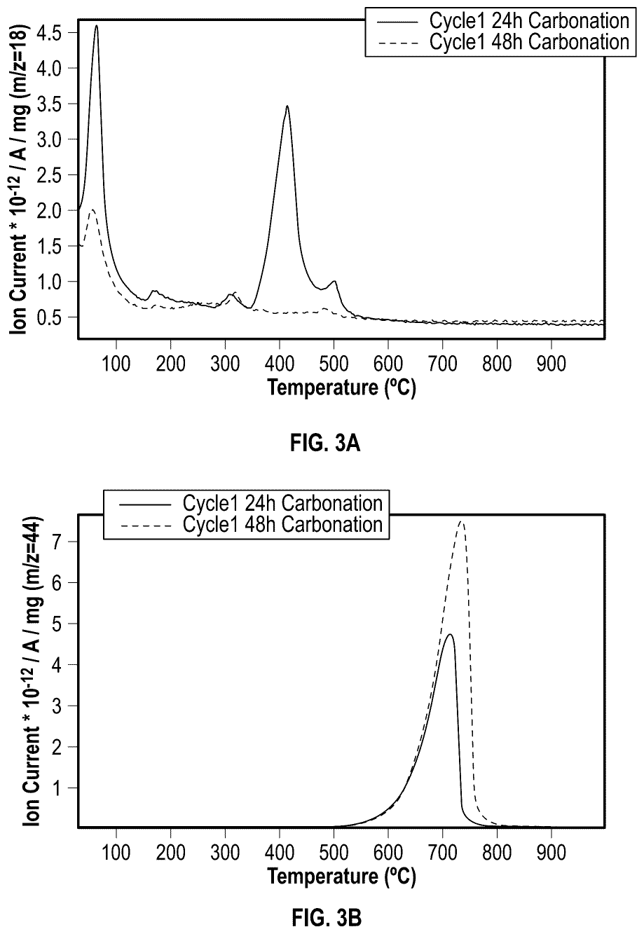

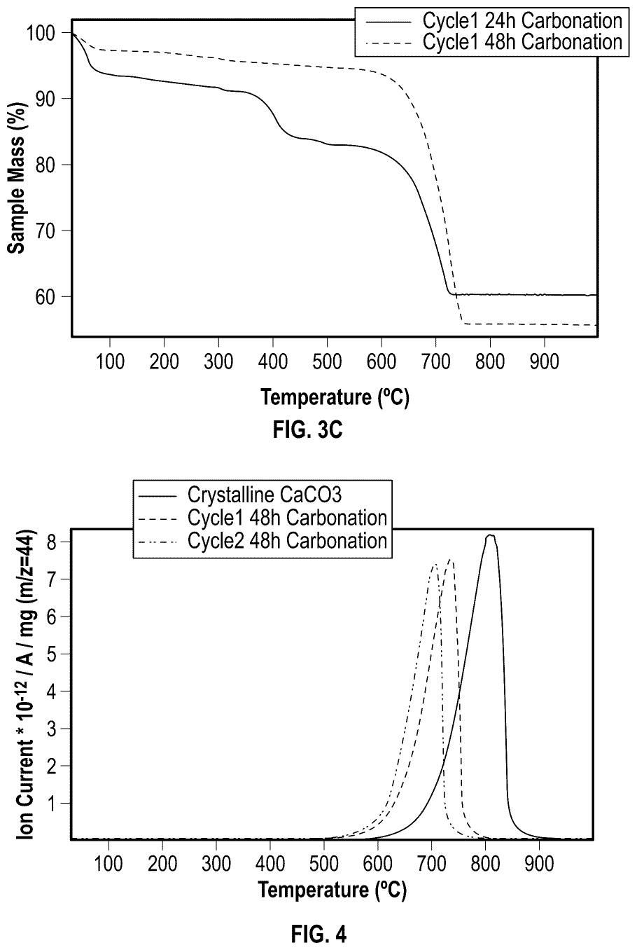

It was found that the minimum time for complete carbonation is between 24-48 hours, as confirmed via TGA-MS analyses. The TGA-MS results of the carbonated samples from cycle 1 showed that there was still portlandite left after 24 hours of carbonation, and all of the portlandite were consumed after 48 hours or longer time of carbonation (Shown in FIGS. 3A, 3B, and 3C). Carbonation times may therefore be limited to 48 hours.

### Calcination (Regeneration Step)

A small but known amount (8-15 mg) of the fully carbonated samples were loaded on to the TGA-MS to understand its thermal decomposition behavior. The remaining carbonated sample was loaded onto ceramic crucibles and heated in a Thermo Scientific Barnstead benchtop muffle furnace at 800° C. for 1.5 hours to thermally decompose all the carbonates (Eq.(3)) into CaO. This regenerated quicklime was ground up and reused for subsequent hydration-carbonation cycles.

### Cyclic Carbon Capture Process Demonstration

For demonstration of cyclability, the hydration-carbonation-calcination cycle was repeated twice. TGA-MS analysis was performed on the produced carbonate for each step to quantify thermal decomposition temperature. It was found that thermal decomposition temperature can be consistently reduced in successive cycles up to 108° C. below that of commercial grade calcite (FIG. 4).

### EXEMPLARY ASPECTS

The following exemplary aspects are provided, the numbering of which is not to be construed as designating levels of importance:

Aspect 1 provides a composition comprising:
an engineered synthetic carbonate comprising a structure, morphology, or combination thereof differing relative to a reference carbonate, wherein
a thermal decomposition threshold of the engineered synthetic carbonate is in a range of from about 5% to about 30% less than the reference carbonate.

Aspect 2 provides the composition of Aspect 1, wherein the structure of the engineered synthetic carbonate comprises a destabilized crystal structure comprising an induced defect, amorphization, a dopant, or a combination thereof.

Aspect 3 provides the composition of any of Aspects 1 or 2, wherein the engineered synthetic carbonate is a calcium-based or a magnesium-based carbonate.

Aspect 4 provides the composition of any of Aspects 2 or 3, wherein the dopant comprises manganese, nickel, copper, lithium, magnesium, or a mixture thereof.

Aspect 5 provides the composition of any of Aspects 2-4, wherein the dopant comprises magnesium.

Aspect 6 provides the composition of any of Aspects 2-5, wherein the dopant ranges from about 0.05 wt % to about 15 wt % of the engineered synthetic carbonate.

Aspect 7 provides the composition of any of Aspects 2-6, wherein the dopant ranges from about 2 wt % to about 7 wt % of the engineered synthetic carbonate.

Aspect 8 provides the composition of any of Aspects 2-7, wherein the dopant is homogenously distributed about the composition.

Aspect 9 provides the composition of any of Aspects 1-8, wherein the thermal decomposition threshold of the engineered synthetic carbonate is less than about 950° C.

Aspect 10 provides the composition of any of Aspects 1-9, wherein the thermal decomposition threshold of the engineered synthetic carbonate is in a range of from about 600° C. to about 950° C.

Aspect 11 provides the composition of any of Aspects 1-10, wherein the thermal decomposition threshold of the engineered synthetic carbonate is in a range of from about 700° C. to about 750° C.

Aspect 12 provides a method of enhancing carbonate-oxide thermal cycling efficiency for CO₂ direct air capture, the method comprising:
modifying a structure and morphology of a carbonate mineral to lower its thermal decomposition threshold for generating an oxide.

Aspect 13 provides the method of Aspect 12, wherein modifying the structure and morphology comprises destabilizing a crystal structure of the carbonate mineral.

Aspect 14 provides the method of Aspect 13, wherein destabilizing the crystal structure comprises at least one of:
introducing defects, amorphization, doping, or a combination thereof.

Aspect 15 provides the method of Aspect 14, wherein a dopant used for doping comprises manganese, nickel, copper, lithium, magnesium, or a mixture thereof.

Aspect 16 provides the method of Aspect 15, wherein the dopant comprises magnesium.

Aspect 17 provides the method of any of Aspects 15 or 16, wherein the dopant ranges from about 0.05 wt % to about 15 wt % of the engineered synthetic carbonate.

Aspect 18 provides the method of any of Aspects 15-17, wherein the dopant is homogenously distributed about the engineered synthetic carbonate.

Aspect 19 provides the method of any of Aspects 12-18, wherein the carbonate mineral is calcium-based or magnesium-based.

Aspect 20 provides the method of any of Aspects 12-19, further comprising:
thermally decomposing the engineered synthetic carbonate mineral at a lower temperature compared to a reference carbonate mineral.

Aspect 21 provides the method of any of Aspects 12-20, wherein the thermal decomposition threshold of the engineered synthetic carbonate is less than about 950° C.

Aspect 22 provides the method of any of Aspects 12-21, wherein the thermal decomposition threshold is in a range of from about 600° C. to about 800° C.

Aspect 23 provides the method of any of Aspects 12-22, wherein the thermal decomposition threshold of the engineered synthetic carbonate is in a range of from about 700° C. to about 750° C.

Aspect 24 provides a method for capturing carbon dioxide, the method comprising:
contacting carbon dioxide with an engineered synthetic carbonate comprising a structure, morphology, or combination thereof differing relative to a reference carbonate; and
exposing the contacted engineered synthetic carbonate to a temperature less than about 950° C. to thermally decompose the engineered synthetic carbonate.

Aspect 25 provides the method of Aspect 24, wherein the engineered synthetic carbonate is a calcium-based or a magnesium-based carbonate.

Aspect 26 provides the method of any of Aspects 24 or 25, wherein the structure of the engineered synthetic carbonate comprises a destabilized crystal structure comprising an induced defect, amorphization, a dopant, or a combination thereof.

Aspect 27 provides the method of Aspect 26, wherein the dopant comprises manganese, nickel, copper, lithium, magnesium, or a mixture thereof.

Aspect 28 provides the method of any of Aspects 26 or 27, wherein the dopant comprises magnesium.

Aspect 29 provides the method of any of Aspects 26-28, wherein the dopant ranges from about 0.05 wt % to about 15 wt % of the engineered synthetic carbonate.

Aspect 30 provides the method of any of Aspects 26-29, wherein the dopant ranges from about 2 wt % to about 7 wt % of the engineered synthetic carbonate.

Aspect 31 provides the method of any of Aspects 26-30, wherein the dopant is homogenously distributed about the engineered synthetic carbonate.

Aspect 32 provides the method of any of Aspects 24-31, wherein the temperature is less than about 950° C.

Aspect 33 provides the method of any of Aspects 24-32, wherein the temperature is in a range of from about 600° C. to about 800° C.

Aspect 34 provides the method of any of Aspects 24-33, wherein the temperature is in a range of from about 700° C. to about 750° C.

Aspect 35 provides the method of any of Aspects 24-34, wherein contacting carbon dioxide with an engineered synthetic carbonate occurs for a time ranging from about 2 hours to about 72 hours.

Aspect 36 provides the method of any of Aspects 24-34, wherein contacting carbon dioxide with an engineered synthetic carbonate occurs for a time ranging from about 10 hours to about 48 hours.

Aspect 37 provides the method of any of Aspects 24-34, further comprising contacting the engineered synthetic carbonate with water.

Aspect 38 provides the method of Aspect 37, wherein the water is in liquid or gas form.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. A comma can be used as a delimiter or digit group separator to the left or right of a decimal mark; for example, “0.000,1” is equivalent to “0.0001.” All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

What is claimed is:

1. A composition comprising:
an engineered synthetic carbonate comprising a structure, morphology, or combination thereof differing relative to a reference carbonate, wherein
a thermal decomposition threshold of the engineered synthetic carbonate is in a range of from about 5% to about 30% less than the reference carbonate.

2. The composition of claim 1, wherein the structure of the engineered synthetic carbonate comprises a destabilized crystal structure comprising an induced defect, amorphization, a dopant, or a combination thereof.

3. The composition of claim 1, wherein the engineered synthetic carbonate is a calcium-based or a magnesium-based carbonate.

4. The composition of claim 2, wherein the dopant comprises manganese, nickel, copper, lithium, magnesium, or a mixture thereof.

5. The composition of claim 2, wherein the dopant comprises magnesium.

6. The composition of claim 2, wherein the dopant ranges from about 0.05 wt % to about 15 wt % of the engineered synthetic carbonate.

7. The composition of claim 1, wherein the thermal decomposition threshold of the engineered synthetic carbonate is in a range of from about 600° C. to about 950° C.

8. A method of enhancing carbonate-oxide thermal cycling efficiency for CO₂ direct air capture, the method comprising:
modifying a structure and morphology of a carbonate mineral to lower its thermal decomposition threshold for generating an oxide.

9. The method of claim 8, wherein modifying the structure and morphology comprises destabilizing a crystal structure of the carbonate mineral.

10. The method of claim 9, wherein destabilizing the crystal structure comprises at least one of:
introducing defects, amorphization, doping, or a combination thereof.

11. The method of claim 10, wherein a dopant used for doping comprises manganese, nickel, copper, lithium, magnesium, or a mixture thereof.

12. The method of claim 11, wherein the dopant ranges from about 0.05 wt % to about 15 wt % of the carbonate mineral.

13. The method of claim 8, wherein the carbonate mineral is calcium-based or magnesium-based.

14. The method of claim 8, further comprising:
thermally decomposing the carbonate mineral at a lower temperature compared to a reference carbonate mineral.

15. The method of claim 8, wherein the thermal decomposition threshold of the carbonate mineral is less than about 950° C.

16. A method for capturing carbon dioxide, the method comprising:
contacting carbon dioxide with an engineered synthetic carbonate comprising a structure, morphology, or combination thereof differing relative to a reference carbonate; and
exposing the contacted engineered synthetic carbonate to a temperature less than about 950° C. to thermally decompose the engineered synthetic carbonate.

17. The method of claim 16, wherein the structure of the engineered synthetic carbonate comprises a destabilized crystal structure comprising an induced defect, amorphization, a dopant, or a combination thereof.

18. The method of claim 17, wherein the dopant comprises magnesium.

19. The method of claim 17, wherein the dopant ranges from about 0.05 wt % to about 15 wt % of the engineered synthetic carbonate.

20. The method of claim 16, wherein the temperature is in a range of from about 600° C. to about 800° C.
